(19) United States
(12) Patent Application Publication
(10) Pub. No.: US 2026/0051477 A1
(43) Pub. Date: Feb. 19, 2026

(54) RECHARGEABLE ION BATTERIES WITH POLYANILINE-BASED CATHODE AND LEAN ELECTROLYTE

(71) Applicant: 2D POLYMER BATTERIES, LLC, Vernon Hills, IL (US)

(72) Inventor: Oleg POSUDIIEVSKYI, Kyiv (UA)

(21) Appl. No.: 19/103,364

(22) PCT Filed: Mar. 14, 2024
(86) PCT No.: PCT/US2024/019824

§ 371 Date: Feb. 12, 2025

Related U.S. Application Data
(60) Provisional application No. 63/452,748, filed on Mar. 17, 2023.

(51) Int. Cl. H01M 4/36; H01M 4/02; H01M 4/583; H01M 4/60; H01M 4/62; H01M 10/054; H01M 10/0568; H01M 50/417

(52) U.S. Cl. CPC H01M 4/364; H01M 4/583; H01M 4/606; H01M 4/622; H01M 4/625; H01M 10/054; H01M 10/0568; H01M 50/417; H01M 2004/028

(57) ABSTRACT

A unique framework for rocking-chair type sodium ion and potassium ion batteries is disclosed. In the case of a sodium ion battery, the battery includes a first electrode operatively assembled as the anode of said battery and includes a source of sodium ions. The battery includes a second electrode operatively assembled as the cathode of the battery and includes at least one polymer binder, a conductive carbon-based material, and an active material. The battery further includes an electrolyte disposed between said first and said second electrodes that supports electrochemical transport of the sodium ions. The active material includes a binary composite; the binary composite includes polyaniline polymer and a graphene-based material. The first electrode, second electrode, and electrolyte are operatively assembled to function as a rocking chair-type sodium-ion battery.

### REFERENCE TO RELATED APPLICATIONS

This application is a U.S. National Stage under 35 USC 371 of International Patent Application Serial No. PCT/US2024/019824, filed on Mar. 14, 2024, which claims priority to, and the benefit of U.S. Provisional Patent Application No. 63/452,748 entitled “SODIUM BATTERIES WITH POLYANILINE BASED CATHODE AND LEAN ELECTROLYTE”, which was filed in the United States Patent and Trademark Office on Mar. 17, 2023, the contents of which are incorporated by reference in their entirety as if fully set forth herein.

### TECHNICAL FIELD

This disclosure relates to rechargeable metal-ion batteries, in particular, rechargeable metal-ion batteries utilizing a composite of polyaniline and a graphene-based material as an active component of the battery cathode.

### BACKGROUND

Rechargeable batteries are a type of secondary battery that can be recharged and used multiple times, making them an environmentally friendly and cost-effective alternative to disposable batteries. They are widely used in portable electronic devices such as smartphones, laptops, and cameras, as well as in larger applications like electric vehicles and energy storage systems. The most common types of rechargeable batteries are nickel-cadmium, nickel-metal hydride, and lithium-ion batteries. Each type of rechargeable battery has its own unique characteristics, including energy density, voltage, and discharge rate, making them well-suited for different applications. Rechargeable batteries must be properly maintained, including being stored correctly, recharged correctly, and being used within the operating temperature range to ensure their performance and longevity. Lightweight rechargeable batteries possessing high energy capacity is a quest of autonomous energetics.

A typical metal-ion battery includes an anode, a cathode, and an electrolyte separating the anode and cathode. The electrolyte is typically a liquid or a solid that contains the metal ions, which serve as the charge carriers between the anode and cathode. When the battery is charged, these ions move from the cathode to the anode through the electrolyte, and when the battery is discharged, they move in the opposite direction.

The separator in a battery with a liquid electrolyte acts as a barrier between the anode and cathode, preventing electrical short-circuits while allowing the flow of metal ions to occur. The separator is typically a porous material, usually made of polypropylene, that is soaked in the electrolyte. It allows ions to flow while retaining the structure of the battery. The separator plays a crucial role in maintaining the stability and safety of the battery, ensuring that the battery operates smoothly and efficiently.

Lithium-ion batteries are widely used as autonomous power sources for various portable electronic devices such as mobile phones, cameras, audio equipment, laptop computers, etc., as well as in electric and hybrid vehicles and power grid systems.

Sodium-ion batteries have been created as an alternative to lithium-ion batteries. The development of sodium-ion batteries was motivated by a greater availability of sodium precursors for the battery as well as its lower cost.

The active material of the anode in a sodium-ion battery usually includes sodium metal, or: a sodium alloy of Sn, Sb, Bi, Si, Ge, Si or P; hard or soft carbon materials; a material including graphene; a transition metal compound; or a composite based thereof. (I. Hasa et al. Challenges of today for Na-based batteries of the future: From materials to cell metrics. J. Power Sources, 2021, Vol. 482, 228872).

The liquid electrolyte usually consists of a solution of a sodium salt, or mixture of salts in an aprotic organic solvent, or a mixture of aprotic organic solvents. Such liquid electrolytes are usually located within the pores of both the anode and cathode with a separator such as a porous polypropylene membrane between them. The quantity and concentration of the liquid electrolyte plays a role in simultaneously providing the lowest battery weight and highest level of ion conductivity.

The electrochemically active material of the cathode of a sodium-ion battery, for example, is one of the most important factors that determines the energy storage capacity of the device as a whole. The active material of the cathode is usually a material including inorganic, transition metal-containing cathode materials, such as layered sodium oxides, polyanionic compounds, and Prussian blue analogues which are promising prospects for application in sodium-ion batteries in the current stage. (Yu. Huang et al., “Electrode Materials of Sodium-Ion Batteries toward Practical Application”, ACS Energy Lett., 2018, Vol. 3, P. 1604; I. Hasa et al. Challenges of today for Na-based batteries of the future: From materials to cell metrics. J. Power Sources, 2021, Vol. 482, 228872; Quan Pei et al., “Improving the Na_{0.67}Ni_{0.33}Mn_{0.67}O₂ Cathode Material for High-Voltage Cyclability via Ti/Cu Codoping for Sodium-Ion Batteries”, ACS Appl. Energy Mater., 2022, Vol. 5, P. 1953; S. Wang et al., “Carbon-Modified NASICON Na₄FeV(PO₄)₃ Cathode with Enhanced Kinetics for High-Performance Sodium-Ion Batteries”, ACS Appl. Energy Mater., 2022, Vol. 5, P. 9616; W. Hua et al., “Preparation method and application of Prussian blue analogue cathode material”, China Patent Application No. CN115207316A, (2022); S. Xu et al., “Promising Cathode Materials for Sodium-Ion Batteries from Lab to Application”, ACS Cent. Sci., 2023, Vol. 9, P. 2012; L. Wang et al., “Research Progress and Modification Measures of Anode and Cathode Materials for Sodium-Ion Batteries”, ChemElectroChem, 2024, Vol. 11, e202300414.)

However, achieving a specific capacity greater than 150 mAh/g using known materials is rare; furthermore, detrimental degradation reactions using known materials has been shown to affect the material's structure and composition, that limiting the prospect of high-energy sodium-ion batteries. (G. Brugnetti et al. The Role of Surface Coating in P′2-Na_{0.67}Mn_{0.67}Ni_{0.33}O₂: Enhancing Capacity and Stability of Layered Cathodes for Sodium-ion Batteries. Batteries & Supercaps, 2023, e202300332).

It has also been shown that layered Zr-doped NaₓLi_{y}M_{z}Oₐ oxides, where M=Ni, Mn, or Co, can possess sufficiently high specific capacity of about 230 mAh/g at 1.5-4.3 V versus Na⁺/Na potential range, but the presence of Co in the composition leads to greater cost and environmental problems. (K. Y. Chung et al., “Cathode active material for sodium-ion battery, and preparation process thereof”, U.S. Patent Application No., US2021075053A1 (2021).)

A greater specific capacity of about 286 mAh/g was achieved for a manganese-based, layered cathode due to anion redox activity, but a rather low mid-potential value of about 2.5 V, and insufficient cyclability reduced the potential of this material for use in sodium-ion batteries (the specific capacity decreased to about 240 mAh/g at the fifth cycle). (G. Shaohua et al., “Manganese based layered positive electrode material for high-specific-energy sodium-ion battery, and preparation method and application of manganese-based layered positive electrode material”, China Patent Application No. CN115117336A (2022); Qi Wang et al., “Dual Honeycomb-Superlattice Enables Double-High Activity and Reversibility of Anion Redox for Sodium-Ion Battery Layered Cathodes”, Angew. Chem., 2022, Vol. 134, e202206625).

Some organic materials have been used as alternatives for inorganic cathode materials. (X. Yin et al., “Recent Progress in Advanced Organic Electrode Materials for Sodium-Ion Batteries: Synthesis, Mechanisms, Challenges and Perspectives”, Adv. Funct. Mater., 2020, Vol. 30, 1908445; R. Rajagopalan et al., “Understanding the sodium storage mechanisms of organic electrodes in sodium ion batteries: issues and solutions”, Energy Environ. Sci., 2020, Vol. 13, P. 1568.) The characteristic property of these organic materials is the presence of carbon- and heteroatom-containing groups that are capable of reversible electrochemical transformations. The specific capacity of these materials is rarely higher than 150 mAh/g when their discharge potential is great enough, whereas a discharge capacity of these materials can be rather great when their discharge potential is sufficiently low. Accordingly, high-energy sodium-ion batteries utilizing organic cathode materials remains an unresolved challenge in rechargeable battery research and development. Furthermore, in some cases the organic materials are suitable only in dual-ion batteries, because their electrochemical activity is accompanied by insertion/extraction of anions present in the electrolyte of the battery.

For example, a polybenzothiazole-based cathode material can show specific capacity about 150 mAh/g in 1.5-4.0 V versus Na⁺/Na potential range. (W. Gang et al., “Sulfonated polybenzothiazole-based cathode material for sodium-ion battery and preparation method of sulfonated polybenzothiazole-based cathode material”, China Patent Application No. CN114975999A (2022).) In another example, a ladder-type hexaazatriphenylene-based polymer demonstrated a specific capacity of 170-180 mAh/g at 100 mA/g discharge current in 0.9-3.5 V versus Na⁺/Na potential range, but its mid-potential is only about 2 V versus Na⁺/Na. (R. R. Kapacv et al., “Conjugated Ladder-Type Polymer with Hexaazatriphenylene Units as a Cathode Material for Lithium, Sodium, and Potassium Batteries”, ACS Appl. Energy Mater., 2021, Vol. 4, P. 10423.) Furthermore, a modified pyrene-based polymer has demonstrated a specific capacity about 360 mAh/g at 1.0-3.5 V versus Na⁺/Na potential range, but its mid-potential is also about 2 V versus Na⁺/Na, and the relatively low content of the polymer in the cathode mass does not support preparation of a high-energy battery based thereon. (R. Shi et al., “In Situ Polymerized Conjugated Poly(pyrene-4,5,9,10-tetraone)/Carbon Nanotubes Composites for High-Performance Cathode of Sodium Batteries”, Adv. Energy Mater., 2021, Vol. 11, 2002917).

The organic polymer polyaniline by itself has been used as an active component of sodium battery cathodes. Due to the system of conjugated bonds, polyaniline is redox active and through doping can be electrically conductive and capable of reverse electrochemical transformations at high potentials. These characteristics motivate the possibility of using polyaniline as an active component of a sodium-ion battery cathode. For example, self-doped polyaniline has been used as a component of a sodium-ion battery cathode with a reversible specific capacity about 100 mAh/g at a specific discharge current of 50 mA/g. (Y. F. Shen et al., “Poly(diphenylaminesulfonic acid sodium) as a cation-exchange organic cathode for sodium batteries”, Electrochem. Commun., 2014, Vol. 49, P. 5). In another study, self-doped polyaniline showed a capacity of about 133 mAh/g and exhibited high cyclability. (M. Zhou et al., A sulfonated polyaniline with high density and high rate Na-storage performances as a flexible organic cathode for sodium-ion batteries. Chem. Commun., 2015, 51, 14354-14356). Polyaniline hollow nanofibers have been used as a cathode material for sodium-ion batteries exhibiting a reversible capacity of 153 mAh/g. (H. Han et al., Polyaniline hollow nanofibers prepared by controllable sacrifice template route as high-performance cathode materials for sodium-ion batteries. Electrochim. Acta 2019, Vol. 301, 352-358). Finally, hybrid nanocomposites based on hexacyanoferrates of transition metals and polyaniline have displayed a specific discharge capacity up to 150 mAh/g in the cathodes of sodium batteries. (Q. Zhang et al., “Surface engineering induced core-shell Prussian blue@polyaniline nanocubes as a high-rate and long-life sodium-ion battery cathode”, J. Power Sources, 2018, Vol. 395, P. 305.)

However, the specific capacity equal to, or lower than the common 50% doping degree limit of polyaniline (about 150 mAh/g) is relatively low for highly efficient cathodes for sodium batteries to be produced. Indeed, the electrochemical activity of self-doped polyaniline alone at potentials above 1.7 V versus Na⁺/Na is believed to be due to insertion/extraction of sodium cations, while for a common polyaniline (not self-doped), the electrochemical activity in the mentioned potential range is believed to be due to insertion/extraction of anions present in an electrolyte. Accordingly, polyaniline polymer is practically applicable in the cathodes of double-ion batteries only. (M. Zhou et al. A sulfonated polyaniline with high density and high rate Na-storage performances as a flexible organic cathode for sodium ion batteries. Chem. Commun., 2015, 51, 14354-14356; H. Han et al. Polyaniline hollow nanofibers prepared by controllable sacrifice-template route as high-performance cathode materials for sodium-ion batteries. Electrochim. Acta 2019, Vol. 301, 352-358).

Recently, a specific capacity of about 175 mAh/g corresponding to a polyaniline doping above the 50% limit was shown in a lithium-ion battery. (J. Gaubicher et al., “Lithium-Doped Pernigraniline-Based Materials”, International Patent Application Serial No. PCT/EP2015/053689.) A composite of polyaniline and a graphene-based material exhibited considerably greater specific capacity of about 250 mAh/g. (O. Posudiievskyi, International Patent Application Serial No. PCT/IB2018/055009.) However, it should be noted that no evidence of practical, high specific capacity and prolonged charge/discharge cycling of polyaniline has been shown in a sodium-ion battery.

The minimal quantity of anions necessary for 100% doping of polyaniline is believed to be equal to one anion per each nitrogen atom of the polymer, or 1 mole of anions per about 91 grams of the polymer (C₆H₄NH is usually considered as the unit cell of polyaniline), or 1 L of a commonly used liquid organic electrolyte with 1M alkali metal salt concentration per about 91 grams of the polymer. (Y. Yamada et al., “Advances and issues in developing salt concentrated battery electrolytes”, Nat. Energy, 2019, Vol. 4, p. 269; Z. Guo et al., “Toward Full Utilization and Stable Cycling of Polyaniline Cathode for Nonaqueous Rechargeable Batteries”, Adv. Energy Mater., 2023, Vol. 13, 2301520.)

Accordingly, about 11 mL of the electrolyte is theoretically required per approximately 1 gram of the polymer in the cathode mass, or about 15 grams of the electrolyte per 294 mAh of charge, the theoretical charge storage limit of the polymer. Accordingly, the electrolyte weight to cathode capacity ratio (E/C) in such battery is about 50 g/(Ah). This very high E/C value suggests a severe limitation, if not a practical inexpediency of double-ion batteries with polyaniline based cathodes. Indeed, practical lithium-ion batteries exhibit an E/C ratio below 3 g/(Ah). (X. Ren et al., “Enabling High-Voltage Lithium-Metal Batteries under Practical Conditions”, Joule, 2019, Vol. 3, p. 1662; Sh. Chen et al., “Critical Parameters for Evaluating Coin Cells and Pouch Cells of Rechargeable Li-Metal Batteries”, Joule, 2019, Vol. 3, p. 1094; J. Liu et al., “Pathways for practical high-energy long-cycling lithium metal batteries”, Nat. Energy, 2019, Vol. 4, p. 180; H. Li., “Practical Evaluation of Li-Ion Batteries”, Joule, 2019, Vol. 3, p. 911.)

Potassium-ion batteries have been created as another alternative to lithium-ion batteries. The development of potassium-ion batteries was motivated by a greater availability of potassium precursors for the battery and its lower cost in comparison with lithium, as well as by a lower redox potential of potassium in comparison with sodium, a much smaller Stokes' radii of K+ ions in comparison with Li+ and Na+ ions, applicability of aluminum foil instead of copper one as a current collector of an anode and a graphite as an active anode material. (K. Sada et al., “Challenges and Prospects of Sodium-Ion and Potassium-Ion Batteries for Mass Production”, Adv. Energy Mater., 2023, Vol. 13, 2302321; Yan-Song Xu et al., “High-Performance Cathode Materials for Potassium-Ion Batteries: Structural Design and Electrochemical Properties”, Adv. Mater. 2021, Vol. 33, 2100409.)

### SUMMARY

In general, systems and methods providing a new mechanism of polyaniline charge/discharge processes, free from anion participation, and furthermore based on reversible insertion/extraction of cations, in particular sodium and potassium cations are disclosed. The disclosed systems and methods solve the problem of the large quantity of electrolyte previously thought necessary for functioning of polyaniline as an electrochemically active component of a cathode of a rechargeable metal-ion battery, in particular a sodium- and potassium-ion battery, while providing prolonged, reversible charge/discharge cycling of polyaniline. The approach has many positive implications for cathodes of practical rechargeable sodium- and potassium-ion batteries.

It should be understood that, while the present disclosure presents novel battery models utilizing sodium as the mobile cation, other embodiments are equally contemplated wherein the cation is a different species, such as, but not limited to potassium.

The systems and methods disclosed herein present the possibility of rocking chair-like functioning of a fixed-electrolyte battery utilizing polyaniline as the cathode active component. A practical advantage of a constant electrolyte concentration is that the metal-ion conductivity between the electrodes of the batteries is maximized due to the electrode pores being filled, leading to highly efficient metal-ion transport. A minimal quantity of electrolyte sufficient to fill the separator and electrode pores provides an E/C ratio below 7 g/(Ah), comparable with the best known commercial lithium-ion batteries.

In a first general aspect, a sodium-ion battery includes a first electrode operatively assembled as the anode of the battery which provides a source of sodium ions, a second electrode operatively assembled as the cathode of the battery which includes at least one polymer binder, a conductive carbon-based material, and an active material, and an electrolyte disposed between the first and the second electrodes that supports electrochemical transport of the sodium ions. The active material includes a binary composite including: 1) polyaniline polymer, and 2) a graphene-based material. The first electrode, the second electrode, and the electrolyte are operatively assembled to function as a rocking chair-type sodium-ion battery.

In one embodiment, the battery further includes an insulative, porous separator disposed between the first and the second electrode. In this embodiment, the electrolyte is a liquid electrolyte, including at least one aprotic solvent and at least one sodium salt that is soluble in the at least one aprotic solvent. Alternatively, the liquid electrolyte includes at least one ionic liquid, the at least one ionic liquid including at least one sodium salt that is soluble in the at least one ionic liquid. In this embodiment, the insulative, porous separator is soaked in the electrolyte, and the amount of the electrolyte in the battery, expressed as a ratio of the electrolyte weight to the cathode capacity, is less than 7 g/(Ah).

In one embodiment, the electrolyte of the battery is a sodium ion conducting solid. The solid includes: a sodium ion conducting organic polymer; a sodium ion conducting inorganic compound; a sodium-ion conducting ionogel; or a composite material including a sodium ion conducting organic polymer, a sodium ion conducting inorganic compound, a sodium-ion conducting ionogel or a combination thereof.

In a second general aspect, a potassium-ion battery includes a first electrode operatively assembled as the anode of the battery that provides a source of potassium ions, a second electrode operatively assembled as the cathode of the battery that includes at least one polymer binder, a conductive carbon-based material, and an active material, and an electrolyte disposed between the first and the second electrodes that supports electrochemical transport of the potassium ions. The active material includes a binary composite, including polyaniline polymer, and a graphene-based material. The first electrode, second electrode, and electrolyte are operatively assembled to function as a rocking chair-type potassium-ion battery.

In one embodiment of the second general aspect, the battery further includes an insulative, porous separator disposed between the first and the second electrode. In this embodiment, the electrolyte is a liquid electrolyte, including at least one aprotic solvent and at least one potassium salt that is soluble in the at least one aprotic solvent, and at least one ionic liquid including at least one potassium salt that is soluble in the at least one ionic liquid. The insulative, porous separator is soaked in the electrolyte. The amount of the electrolyte in the battery, expressed as a ratio of the electrolyte weight to the cathode capacity, is less than 7 g/(Ah).

In another embodiment of the second general aspect, the electrolyte of the battery is a potassium-ion conducting solid, including a potassium-ion conducting organic polymer, a potassium-ion conducting inorganic compound, a potassium-ion conducting ionogel, or a composite material, including a potassium ion conducting organic polymer, a potassium ion conducting inorganic compound, a potassium ion conducting ionogel, or a combination thereof.

In a third general aspect, a method of fabricating a metal-ion battery is provided. The method includes providing a first electrode including a source of metal ions and operatively assembling the first electrode as an anode of the battery, providing a second electrode and operatively assembling the second electrode as a cathode of the battery. The second electrode includes at least one polymer binder, a conductive carbon-based material and an active material. The method further includes disposing an electrolyte between the first and the second electrode that supports electrochemical transport of metal ions between the first electrode and the second electrode. The active material includes a binary composite including polyaniline and a graphene-based material.

In one embodiment of the third general aspect, the metal is sodium or potassium.

In one embodiment of the third general aspect, the binary composite of polyaniline and a graphene-based material is prepared according to a process including milling a mixture of polyaniline as emeraldine base and a graphene-based material. In a related embodiment, the milling is performed in a solvent-free environment. In another related embodiment, the graphene-based material includes a mixture of multi-, few- and mono-layered graphene particles. In another related embodiment, the mixture is prepared by chemical, mechanochemical, electrochemical, sonochemical or thermochemical exfoliation of particles of graphite, graphene oxide, intercalated graphite or expanded graphite. The mixture of polyaniline as emeraldine base and a graphene-based material can be prepared using a relative weight ratio between about 75:25 and about 99:1 polyaniline to graphene-based material. The method can include an optional step of isolating and purifying the composite of polyaniline and a graphene-based material.

In another embodiment of the third general aspect, the second electrode is formed by a deposition step including depositing a cathode mass onto a current collector, the cathode mass including a binder, a conductive additive, and the active material. In a related embodiment, the binder is water soluble. Furthermore, the deposition step can include preparing a slurry of the cathode mass by mixing the binder, the conductive additive and the active material with water. The binder can be soluble in polar organic solvents. In a related embodiment, the deposition step includes preparing a slurry of the cathode mass by mixing the binder, the conductive additive and the active material with a polar organic solvent. In a related embodiment, the method includes using a slurry the is free of N-methyl pyrrolidone.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### BRIEF DESCRIPTION OF DRAWINGS

The present embodiments are illustrated by way of the figures of the accompanying drawings, which may not necessarily be to scale, in which like references indicate similar elements, and in which:

FIG. 1 illustrates a cross-section of a rechargeable battery employing a polyaniline-based cathode according to one embodiment;

FIG. 2 is a chart plotting specific capacity versus cycle number for a first and second battery cell according to the present disclosure;

FIG. 3 is a chart plotting specific capacity versus cycle number for a third battery cell according to the present disclosure;

FIG. 4 is a chart plotting electric potential versus discharge capacity for the third cell;

FIG. 5 is a chart plotting specific capacity versus cycle number for a fourth battery cell according to the present disclosure; and

FIG. 6 is a chart plotting specific capacity versus cycle number for a fifth battery cell according to the present disclosure.

### DETAILED DESCRIPTION OF ILLUSTRATIVE EMBODIMENTS

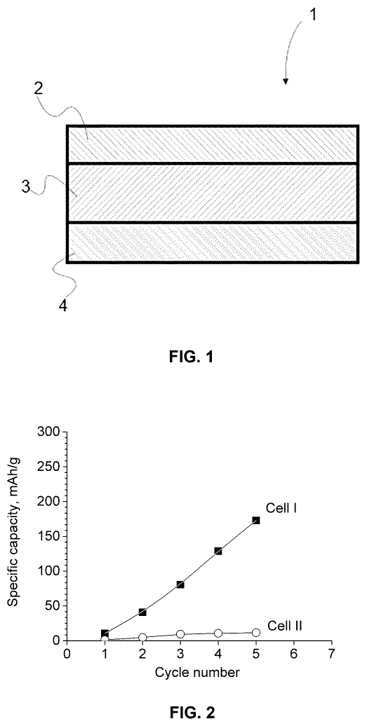

FIG. 1 is an illustrative cross section of a rechargeable battery 1 according to one embodiment. In this embodiment, the active component of the battery cathode is a binary composite of: 1) polyaniline; and 2) a graphene-based material. In this embodiment, rechargeable battery 1 includes an anode layer 2, an electrolyte layer 3, and a cathode layer 4. In this embodiment, anode layer 2 is composed of sodium or a sodium alloy, a composite including sodium, or other anode material, without limitation. Anode layer 2 can alternatively be composed of materials such as, and without limitation, a hard carbon material, a graphene material, a transition metal-based compound, or any combination thereof as an active component. It should be understood that sodiated forms of hard carbon, graphene or transition metal-based materials can be used for optimal battery performance.

In this embodiment, electrolyte layer 3 can be: 1) a porous polymer membrane soaked in a liquid electrolyte that is a solution of a sodium salt, or several sodium salts in an organic aprotic solvent or a mixture of different aprotic solvents, preferably including additives serving to improve the electrode-electrolyte interfaces; 2) a porous separator soaked in an ionic liquid electrolyte that is a solution of a sodium salt, or several sodium salts in an ionic liquid or a mixture of different ionic liquids; 3) a sodium ion conducting solid electrolyte layer including an organic polymer film possessing the ability to conduct sodium ions alone, or in combination with a corresponding sodium salt; 4) a sodium ion conducting inorganic solid; 5) a composite thereof; or 6) a solid ionogel electrolyte.

In this embodiment, cathode layer 4 contains a binary composite of: 1) polyaniline, and 2) a graphene-based material, hereinafter referred to as “PANI/GBM”, as the active component, which is disclosed in International Patent Application Serial No. PCT/IB2018/055009, which is incorporated herein by reference in its entirety. PANI/GBM composite can be prepared by a solvent-free, mechanochemical process including mechanochemical treatment of a mixture of polyaniline as emeraldine base and a mixture of multi-, few-, and mono-layered graphene particles as the GBM. A mechanochemical procedure for the preparation of PANI/GBM composite is analogous to a mechanochemical procedure for preparation of hybrid nanocomposites disclosed in O. Posudievsky et al., “Hybrid Two- and Three-Component Host-Guest Nanocomposites and Method for Manufacturing the Same”, and U.S. patent application Ser. No. 12/623,000, to GM Global Technology Operations, Inc., the latter of which is incorporated herein by reference in its entirety.

In this embodiment, rechargeable battery 1 was shown to exhibit rocking-chair functionality (i.e., sodium cation insertion/extraction induced charge/discharge cycling) utilizing: a sodium metal anode, an electrolyte layer, and the PANI/GBM composite based cathode. The rechargeable battery 1 was assembled in a Swagelok cell in an argon-filled MBRAUN glove box with an oxygen and water content below 0.1 ppm.

Investigating the properties of rechargeable battery 1, several cells were fabricated. A first cell, “Cell I”, included a cathode mass formed from mechanochemically prepared PANI/GBM composite, with a polyaniline-to-GBM weight ratio equal to about 9:1 according to the procedures set forth in International Patent Application Serial No. PCT/IB2018/055009, a polymer binder and a carbon black additive. International Patent Application Serial No. PCT/IB2018/055009 is incorporated herein by reference. The weight ratio of the cathode mass components was 85:10:5 (PANI/GBM composite:polymer binder:carbon black additive). In this example, the polymer binder was a poly[(vinylidene fluoride)-co-hexafluoropropylene] copolymer, and acetone was used as a solvent for preparation of the slurry for deposition of the PANI/GBM composite based cathode mass on a cathode current collector using a doctor blade. The cathode mass loading was performed so as to ensure a unilateral areal capacity of about 2 mAh/cm². To show a rocking-chair functionality (e.g., cation insertion/extraction induced charge/discharge cycling), Cell I utilized an anode produced from a bulky piece of sodium metal, 5.5 mg of the cathode mass, and an electrolyte layer composed of a Celgard 2400 polypropylene membrane (Celgard, LLC, Charlotte, North Carolina, United States) soaked in a mixture of ethylene carbonate-diethyl carbonate (50:50 ratio by volume) containing 0.42 mg of NaClO₄ salt sufficient to ensure only 10% doping degree of polyaniline, present in the cathode mass.

A second cell, “Cell II”, was produced in an analogous procedure as for Cell I, except that a pure polyaniline as emeraldine base was used as the active material of the cathode mass instead of PANI/GBM composite as in Cell I.

A third cell, “Cell III”, was produced in an analogous procedure as for Cell I samples, except that the separator was soaked in a 1M solution of NaClO₄ in an ethylene carbonate-diethyl carbonate mixture (50:50 ratio by volume).

A fourth cell, “Cell IV”, was produced in an analogous procedure as for Cell III, except that polyvinylidene fluoride binder and N-methyl-2-pyrrolidone (NMP) as a solvent were used during preparation of the slurry for deposition of the PANI/GBM based cathode mass on the cathode current collector.

A fifth cell, “Cell V”, was produced in an analogous procedure as for Cell III samples, except that the polymer binder was a mixture of polyolefin grafted acrylic acid copolymer (3 percent by weight of an aqueous solution) and carboxymethylcellulose (2.5 percent by weight of an aqueous solution) in a 1:3 ratio. In this example, double-distilled water was used to prepare a cathode mass slurry which was deposited on a cathode current collector using a doctor blade. The cathode mass was dried at 60° C. in air and subsequently under vacuum at 80° C.

In all cases, a specific capacity was calculated using polyaniline content in the cathode mass. Cycling was performed at 1.7-4.1 V versus Na⁺/Na potential range. Charge and discharge currents were both equal to 15 mA/g. The specific current value was calculated using the entire weight of the cathode mass.

Referring now to FIG. 2, cycling data show increasing discharge specific capacity of polyaniline in Cell I. FIG. 2 illustrates the ability of polyaniline to sustain charge/discharge cycling in the absence of a sufficient number of mobile anions ( 1/10 of the quantity necessary for theoretical 100% doping level) in the electrolyte and to reach about 60% of its theoretical specific capacity of 294 mAh/g at the fifth cycle. This means that the capacity of polyaniline at that cycle was about six times higher than the maximal theoretical value available for anion doping of polyaniline due to the specially restricted content of sodium salt in the electrolyte of cell I. Without wishing to be bound by theory, it is postulated that the steady increase of polyaniline specific capacity is due to progressive sodiation of nitrogen atoms within its structure, as doping/dedoping of polyaniline in Cell I during cycling to such extent was only able to proceed with participation of mobile sodium cations.

FIG. 2 furthermore illustrates that efficient functioning of polyaniline as the active component of the cathode in Cell I is due to the presence of the GBM and its effect on polyaniline, because in the absence of the GBM particles (and therefore in the absence of interaction between the GBM particles and polyaniline macromolecules) the specific capacity of polyaniline in Cell II, which does not contain the GBM in the composition of the cathode mass, reaches only about 1/23 of its maximum theoretical doping level, i.e., more than twice below the theoretical limit of 10% due to the amount of mobile anions in the electrolyte of Cell II.

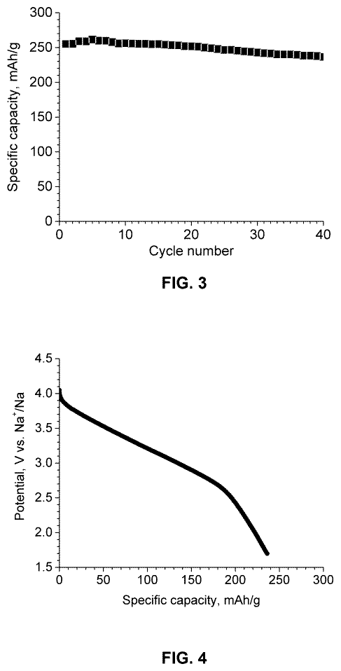

Referring now to FIG. 3, charge-discharge cycling data for Cell III are shown. The polyaniline in Cell III is characterized by a high specific capacity of about 260 mAh/g. In addition, FIG. 4 shows that PANI/GBM composite in Cell III is characterized by a high mid-potential about 3.04 V versus Na⁺/Na. In one optional embodiment, it is conceived that a low quantity of a sodium salt could be dissolved in the organic aprotic solvent as a component of the electrolyte to simultaneously ensure a low battery weight and to provide the necessary level of ion conductivity. These data show that polyaniline-based sodium-ion batteries with a lean electrolyte and a weight-to-capacity ratio below 5 g/(Ah) can perform as well as known commercial lithium-ion batteries.

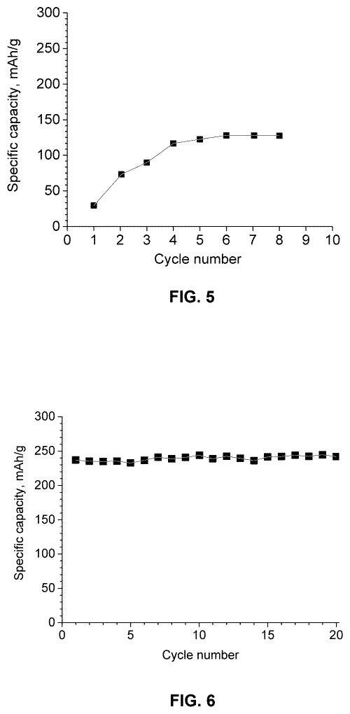

Referring now to FIG. 5, charge-discharge cycling data for Cell IV are shown. From these data it is evident that the usage of a binder such as polyvinylidene fluoride together with a solvent such as (N-methyl pyrrolidone) are contraindicated for the preparation of the PANI/GBM cathode mass slurry and deposition of the cathode mass on the cathode current collector during production of Cell IV, because N-methyl pyrrolidone partially dissolves polyaniline. Dissolution of polyaniline destroys the interaction between polyaniline and GBM, which in turn eliminates proceeding of the new doping mechanism of polyaniline and restricts its specific capacity in Cell IV to a value of 50% doping.

Referring now to FIG. 6, charge-discharge cycling data for Cell V are shown. FIG. 6 shows that aqueous solutions of water-soluble binders such as polyacrylic acid and carboxymethylcellulose can be used for preparation of the cathode mass slurry to provide lower cost for cathode mass preparation and processing, and to reduce usage of organic solvents that pose ecological and environmental hazards associated with battery manufacture.

Electrochemically active organic electrode materials are characterized by ion universality. In a related and analogous embodiment, a rocking-chair potassium-ion battery can be produced with the PANI/GBM composite as an active material of the cathode. Importantly, the K⁺/K potential can be lower than Na⁺/Na potential and even Li⁺/Li potential in specific organic solvents that is useful for increasing the energy density. Similar to sodium-ion batteries, potassium ions do not alloy with aluminum when aluminum foil is used as the anode current collector. Contrary to sodium ions, potassium ions can intercalate in graphite with a high capacity. Potassium ions can exhibit considerably weaker Lewis acidity and smaller Stokes radius in organic solvents compared with lithium ions and sodium ions, thereby demonstrating an increased ionic mobility across the bulk electrolyte and the electrolyte/electrode interface beneficial for the achievement of high-power density.

The potassium ion has a larger radius (1.38 Å) than sodium ion (1.02 Å). Therefore, using conventional inorganic electrode materials for potassium-ion batteries could cause considerable structure deformation, leading to lower low capacity and rapid capacity fading. On the contrary, organic electrode materials assembled due to specific van der Waals forces often possess a large interlayer spacing and flexible structure.

Nevertheless, it has been shown that if an average voltage of the potassium-ion batteries with cathodes based on electrochemically active materials is predominantly below 3V, and capacity of these materials is rarely greater than 150 mAh/g. (X. Zhu et al. Recent Advances in Polymers for Potassium Ion Batteries. Polymers, 2022, 14, 5538; M. Wang et al. Organic Electrode Materials for Non-aqueous K-Ion Batteries. Trans. Tianjin University, 2021, Vol. 27, 1-23; S. Liu et al. Challenges and Strategies toward Cathode Materials for Rechargeable Potassium-Ion Batteries. Adv. Mater. 2021, Vol. 33, 2004689; Lin Li et al. Cathode materials for high-performance potassium-ion batteries. Cell Reports Physical Science 2, 100657).

In particular, it has been shown that polyaniline can be used as an electrochemically active material of the potassium-ion battery cathode; however, polyaniline capacity was also below 150 mAh/g, though the average voltage of the battery was about 3V. Besides, electrochemical activity of polyaniline in this case was due to insertion/extraction of anions, so that the disclosed battery was a double-ion battery potassium battery. (H. Gao et al. A High-Energy-Density Potassium Battery with a Polymer-Gel Electrolyte and a Polyaniline Cathode. Angew. Chem. Int. Ed. 2018, Vol. 57, 5449-5453).

A number of illustrative embodiments have been described. Nevertheless, it will be understood that various modifications may be made without departing from the spirit and scope of the various embodiments presented herein. Accordingly, other embodiments are within the scope of the following claims.

What is claimed is:

1. A sodium-ion battery, comprising:
a first electrode operatively assembled as the anode of said battery and comprising a source of sodium ions;
a second electrode operatively assembled as the cathode of said battery and comprising at least one polymer binder, a conductive carbon-based material, and an active material; and
an electrolyte disposed between said first and said second electrodes that supports electrochemical transport of said sodium ions;
wherein said active material comprises a binary composite comprising: 1) polyaniline polymer, and 2) a graphene-based material; and
wherein said first electrode, said second electrode, and said electrolyte are operatively assembled to function as a rocking chair-type sodium-ion battery.

2. The battery of claim 1, further comprising an insulative, porous separator disposed between said first and said second electrode;
wherein said electrolyte is a liquid electrolyte comprising:
at least one aprotic solvent and at least one sodium salt that is soluble in said at least one aprotic solvent; or
at least one ionic liquid comprising at least one sodium salt that is soluble in said at least one ionic liquid; and
wherein said insulative, porous separator is soaked in said electrolyte; and
wherein the amount of said electrolyte in the battery, expressed as a ratio of the electrolyte weight to the cathode capacity, is less than 7 g/(Ah).

3. The battery of claim 1, wherein said electrolyte is a sodium ion conducting solid comprising:
a sodium ion conducting organic polymer;
a sodium ion conducting inorganic compound;
a sodium-ion conducting ionogel; or
a composite material comprising said sodium ion conducting organic polymer, said sodium ion conducting inorganic compound, said sodium-ion conducting ionogel or a combination thereof.

4. A potassium-ion battery, comprising:
a first electrode operatively assembled as the anode of said battery and comprising a source of potassium ions;
a second electrode operatively assembled as the cathode of said battery and comprising at least one polymer binder, a conductive carbon-based material, and an active material; and
an electrolyte disposed between said first and said second electrodes that supports electrochemical transport of said potassium ions;
wherein said active material comprises a binary composite comprising: 1) polyaniline polymer, and 2) a graphene-based material; and
wherein said first electrode, said second electrode, and said electrolyte are operatively assembled to function as a rocking chair-type potassium-ion battery.

5. The battery of claim 4, further comprising an insulative, porous separator disposed between said first and said second electrode;
wherein said electrolyte is a liquid electrolyte comprising:
at least one aprotic solvent, and at least one potassium salt that is soluble in said at least one aprotic solvent;
at least one ionic liquid comprising at least one potassium salt that is soluble in said at least one ionic liquid; and
wherein said insulative, porous separator is soaked in said electrolyte; and
wherein the amount of said electrolyte in the battery, expressed as a ratio of the electrolyte weight to the cathode capacity, is less than 7 g/(Ah).

6. The battery of claim 4, wherein said electrolyte is a potassium-ion conducting solid, comprising:
a potassium-ion conducting organic polymer;
a potassium-ion conducting inorganic compound;
a potassium-ion conducting ionogel; or
a composite material comprising said potassium ion conducting organic polymer, said potassium ion conducting inorganic compound, said potassium ion conducting ionogel, or a combination thereof.

7. A method of fabricating a metal-ion battery, comprising:
providing a first electrode comprising a source of metal ions and operatively assembling said first electrode as an anode of said battery;
providing a second electrode and operatively assembling said second electrode as a cathode of said battery, wherein said second electrode comprises at least one polymer binder, a conductive carbon-based material and an active material;
disposing an electrolyte between said first and said second electrode that supports electrochemical transport of metal ions between said first electrode and said second electrode;
wherein said active material comprises a binary composite comprising polyaniline and a graphene-based material.

8. The method of claim 7, wherein said metal is sodium or potassium.

9. The method of claim 7, wherein said binary composite of polyaniline and a graphene-based material is prepared according to a process comprising milling a mixture of polyaniline as emeraldine base and a graphene-based material.

10. The method of claim 9, wherein said milling is performed in a solvent-free environment.

11. The method of claim 9, wherein said graphene-based material comprises a mixture of multi-, few- and mono-layered graphene particles.

12. The method of claim 11, wherein said mixture is prepared by chemical, mechanochemical, electrochemical, sonochemical or thermochemical exfoliation of particles of graphite, graphene oxide, intercalated graphite or expanded graphite.

13. The method of claim 9, wherein said mixture of polyaniline as emeraldine base and a graphene-based material is prepared using a relative weight ratio between about 75:25 and about 99:1 polyaniline to graphene-based material.

14. The method of claim 9, further comprising an optional step of isolating and purifying said composite of polyaniline and a graphene-based material.

15. The method of claim 7, wherein said second electrode is formed by a deposition step comprising depositing a cathode mass onto a current collector, said cathode mass comprising a binder, a conductive additive, and said active material.

16. The method of claim 15, wherein said binder is water soluble.

17. The method of claim 16, wherein said deposition step comprises preparing a slurry of said cathode mass by mixing said binder, said conductive additive and said active material with water.

18. The method of claim 15, wherein said binder is soluble in polar organic solvents.

19. The method of claim 18, wherein said deposition step comprises preparing a slurry of said cathode mass by mixing said binder, said conductive additive and said active material with a polar organic solvent.

20. The method of claim 19, wherein said slurry is free of N-methyl pyrrolidone.
